(19) United States
(12) Patent Application Publication
(10) Pub. No.: US 2005/0083492 A1
(43) Pub. Date: Apr. 21, 2005

(54) Projection system

(76) Inventor: Thomas Taubenberger, Biberbach (DE)

Correspondence Address: STAAS & HALSEY LLP, SUITE 700, 1201 NEW YORK AVENUE, N.W., WASHINGTON, DC, 20005, US

(21) Appl. No.: 10/499,520

(22) PCT Filed: Dec. 9, 2002
(86) PCT No.: PCT/DE02/04519

(30) Foreign Application Priority Data
Dec. 21, 2001 (DE) 101 63 481.1

(51) Int. Cl. G03B 21/26

(52) U.S. Cl. 353/94

(57) ABSTRACT

A projection system has a projection device which is used to produce a projection by emitting projection radiation, and a diaphragm device which is arranged in the beam path of the projection radiation in such a way that part of the projection is blocked out, thus causing a continuous reduction of the intensity of the projection radiation in the blocked-out part of the projection.

### CROSS REFERENCE TO RELATED APPLICATIONS

This application is based on and hereby claims priority to PCT Application No. PCT/DE02/04519 filed on Dec. 9, 2002 and German Application No. 101 63 481.1 filed on Dec. 21, 2001, the contents of which are hereby incorporated by reference.

### BACKGROUND OF THE INVENTION

The invention relates to a projection system with a projection device and a masking device.

To realize large-format image projection, a large-format image is produced by projecting beams onto a projection screen, such as a projection wall. In order to project a large-format image which is as large as possible, several individual projection systems are used, generally a large number of them, the individual projections from which are combined to form one overall projection, the large-format image projection. Accordingly, the large-format image is made up of several individual images, generally many of them, each produced by one of the individual projections.

TAN projection technology, TANORAMA™ POWERWALL, TAN Projektionstechnologie GmbH & Co. KG. as at 17.12.2001 can be obtained from http://www.tan.de. (“the TAN reference”) discloses various ways of realizing large-format image projections, which can be distinguished, for example, as being either an arrangement or number of individual projection systems, or a form of overall projection.

FIG. 4 outlines the design 400 of a large-format image projection system 400 with a first projector 401 and a second projector 402 together with a large-format screen 408.

The first projector 401 and the second 402 each emit projection beams in the form of an appropriate beam or projection cone, 403 and 404 respectively. The corresponding projections 405 and 406 respectively are rendered visible to a viewer by the projection beams concerned, 403 and 404 respectively, being incident on the large-format screen 408.

With such large-format image projection, as illustrated by the example in FIG. 4, overlaps arise in the transitional regions between the individual projections or individual images, as applicable, in each of which two individual projections overlap. Such an overlap region is shown, for example in FIG. 4.,407.

Such an overlap or mutual coverage is also referred to as a blend or blending region.

Because the intensities of the beams from each of the overlapping projections or projection beams are additive, in the blending regions brightness errors arise which are visible and distracting to a viewer of the projected large-format image (blending problem).

FIG. 5 illustrates this blending problem by reference to an appropriate additive intensity pattern 500 across a screen width 504 due to two projections 501 and 502 which overlap on a section 503 of the screen.

In order to achieve an (additive) intensity pattern (FIG. 3, 300) which is uniform, correct and therefore not distracting to the viewer from two projections (FIG. 3, 301, 302) which overlap over a section (FIG. 3, 303), the intensity of each individual projection (FIG. 3, 301, 302) must be continuously reduced (FIG. 3), starting from the beginning (FIG. 3, 306) of the overlap region (FIG. 3, 303) through to an edge (FIG. 3, 307) of the overlap region or of the individual projection concerned (FIG. 3, 301, 302), as applicable.

The addition of the intensities of the mutually overlapping individual projections then gives the desired brightness distribution (FIG. 3), which is not distracting to the viewer when the large-format image is rendered visible on a screen.

FIG. 3 shows such a uniform (additive) intensity pattern 300 across a screen width 304, from two projections 301 and 302 which overlap over a section 303 and are subject to an intensity reduction 306-307 out to the edge 307.

Depending on the projector technology used, i.e. the type of projectors used, another problem can occur, which results in non-uniform brightness distributions on a projection screen.

Depending on their design, LCD projectors (in the case of LCD projection systems) or DLP projectors (in the case of DLP projection systems), which correspondingly use respectively LCD or DLP technology to generate an image and which are known from the TAN reference, for example, emit not only the projection beams required for generating the image but also clearly visible stray beams or stray light, as applicable.

In the case of any LCD or DLP projector involved, this stray emission or stray light escapes together with an image-generating element, an LCD or a DLP module, causing intensity errors on the projection screen in addition to the projected image.

With the systems available until now for large-format or multi-image projection, i.e. projection systems with at least two individual projections combined, for example the LCD or DLP projection systems known from Product information on LCD or DLP projection systems, as at 17.12.2001 can be obtained from http://www.barco.com/projection_systems/(“the “Product Information” reference”), an intensity pattern as shown in FIG. 3 which is uniform, non-distracting and hence desired, is generated with the individual projections concerned by electronic techniques (soft edge blending).

To achieve this with these known projection systems, based on the soft edge blending technique, requires additional demanding and hence costly electronic modules, with additional software components for making the appropriate changes (as illustrated in FIG. 3) in the brightness or intensity pattern, as applicable, of the projections.

With the LCD or DLP projection systems, known from the Product Information reference, the soft edge blending technique described is both realized in integrated form in each of the projectors used, and can also be obtained as a supplementary solution subject to appropriate surcharges.

With the LCD or DLP projection systems known from the Product Information reference, there is in addition a mutual dependence between the appropriate blending control electronics for eliminating the blending problem and the projector used in each case.

Because of the technology used, the LCD or DLP projection systems known from the Product Information reference can only affect the image elements (pixels) which are contained in a projected image, so that even with these known projection systems the stray light problem described is not eliminated.

Consequently, one possible object of this invention is to specify a projection system which is simpler and cheaper to realize than the known ones, and which permits projections to be better and more efficiently blended into each other.

### SUMMARY OF THE INVENTION

The inventor proposes a projection system has a projection device, set up to create a projection by emitting a projection beam, together with a masking device which is inserted into the projection beam in such a way that part of the projection is masked out, with the effect that across the section of the projection which is masked out there is a continuous reduction in the intensity of the projection beam.

Here, the term projection refers to a multi-dimensional array of beams, created by the projection beam emitted from the projection device, generally a projection cone, with a prescribed distribution of intensity for the projection beam.

When used in connection with the invention, the term ‘beam path’ means a path traversed by the emitted projection beam.

It follows from this that if a projection screen is introduced into the beam path of the projection beam, which the projection beam strikes, the projection can be rendered visible on the projection screen.

The physical fundamentals of a light beam, in particular when a beam is interrupted at the edge of a mask, are described in Jost J. Marchesi, Handbuch der Fotografie—Band 1/Die Grundlagen {Manual of Photography—Vol. 1/Fundamentals} Verlag Photographie, ISBN 3723100244. The fundamentals of optical representations are described in Christian Hofmann, Die optische Abbildung, 1. Auflage {Optical representation, 1^{st} Edition}, page 175, Akademische Verlagsgesellschaft Geest & Porting K.-G. Leipzig, 1988 .

The physical effect which is exploited with the invention is so-called vignetting. The term vignetting refers to a decrease in the brightness of an image toward the edge of the image, due to physical causes. It is caused by peripheral beams being obscured when they pass through an aperture in a mask. As a result, not all of the beams emerging from a point source of light reach the projection surface. Some of the beams are shaded out. This results in a pattern of decreasing brightness toward the edge of the image.

One particular advantage of the invention relates to the fact that it provides a mechanical (hardware) solution to the blending problem described.

This solution, using the invention, is thus simpler and cheaper to realize than, for example, the electronic (software) solution known from the related art.

By comparison with this known electronic solution from the related art, the invention also has the advantage that the projection system is independent of any particular projector type which is being used. The projection system can be realized with any required type of projector, for example an LCD or a DLP projector.

Furthermore, the projection system has the advantage that any alignment, i.e. adjustment of the masked-out section for the projection conditions, is substantially simplified, for example by appropriate geometrical shaping or insertion of the masking device into the beam path.

Thus it is possible, for example, by a simple change in the depth and/or position of insertion into the beam path to change, and thus adjust, the part of it which is masked out.

Furthermore, the projection system has the advantage that stray projection light which escapes, such as with LCD and DLP projectors, can be eliminated with the projection system.

For the purpose of solving the blending problem described, it is useful that, with a development, the section of the projection which is masked out lies in a peripheral area of the projection. The intensity of the projection beam can thereby be reduced in a direction toward the edge of the projection.

Furthermore, it is also useful for solving the blending problem that the intensity is reduced down to zero in the section of the projection which is masked out. This makes it possible to achieve a continuous reduction in the beam intensity down to zero toward the edge of the projection.

By using an appropriate embodiment of the masking device, for example by an appropriate shape, depth and/or appropriate material, a continuous reduction in the intensity can be selectively achieved, in accordance with a prescribable functional rule.

Because of the simplicity of realizing it, one useful rule is a linear function, i.e. a linear reduction of the beam intensity. Other functional rules are possible, such as a logarithmic rule for the graph of the reduction in the beam intensity, or a rule which can be specified by a polynomial function.

The material used for the mask can be a light-tight material, such as aluminium or a metal.

Alternatively, use can be made of a non-light-tight material, such as tinted plexiglass or tinted filter glass. The reduction in the intensity of the beam, and its functional form, is achieved by the filter coating of the material and/or by changing the optical transparency of the material itself. The intensity graphs are then determined correspondingly for each case.

The flexibility of this projection system can be increased by inserting the masking device into the beam path in such a way that the section which is masked out can be altered. This flexibility can be realized, for example, by a simple change in the insertion depth and/or position, in each case by displacing the masking device in an appropriate direction within the beam path.

For this purpose, a development provides an appropriate mechanical holder with vertical and horizontal guides for the masking device or devices, as applicable.

Because the projection system is independent of the particular projector system which is used, in the developments it is possible to use any required projector types, such as an LCD or a DLP projector the Product Information reference .

For the purpose of producing a prescribed projection pattern or projection shape, it is helpful to use several masking devices, each of which can be used to mask out part of the projection.

Here, the several masking devices can be inserted into the beam path in such a way that the part of the projection which is not masked out has the prescribed shape or pattern, as applicable. An example of such a shape or pattern might be a projection cone with a rectangular cross-section.

In a development, the projection system has a projection screen for showing the projection.

In a refinement to the projection system, a large-format projection unit is realized in such a way that at least two of the projection systems are oriented with respect to each other in such a way that the sections which are masked out from each of the projections overlap one another, at least partially.

In the overlapping section, a so-called blending (blending region) occurs, in which the intensities of the overlapping projections add together to form a composite total intensity.

In this case it is useful, in order to attempt to achieve a blending region which is as far as possible uniform and non-distracting to a viewer, if the overlap is effected in such a way that the combination of the intensities of the two projection beams produces an intensity with a constant pattern in the overlapping section.

When realizing the largest possible large-format projection unit, such as is required for presentation purposes, for example at exhibitions or similar demonstration events, it is useful to use or combine several or many of the projection units, which are oriented in such a way with respect to each other that they produce a large-format projection with a prescribable form, in particular a large-format projection cone with a rectangular cross-section.

Such a large-format projection cone, when it strikes a large-format projection screen, then produces a regular large-format projection image with transitions or blending regions, between the individual projections, which are scarcely visible to a viewer.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is an optical hardware edge blending system (H-EBS) in accordance with an exemplary embodiment;

FIG. 2 is a sketch of a multi-image projection with a multi-image projection system with an optical hardware edge blending system in accordance with an exemplary embodiment;

FIG. 3 is a sketch showing a composite uniform intensity pattern for two projection systems or projections combined together with no blending problem;

FIG. 4 is a sketch of the construction of a multi-image projection system using two projection systems combined together;

FIG. 5 is a sketch showing a composite, non-uniform intensity pattern for two projection systems combined together where there is a blending problem;

FIG. 6 is a sketch of the construction of a hardware edge blending (H-EBS) multi-image projection system using two H-EBS projection systems combined together.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

Exemplary embodiment: an optical hardware edge blending system (H-EBS)

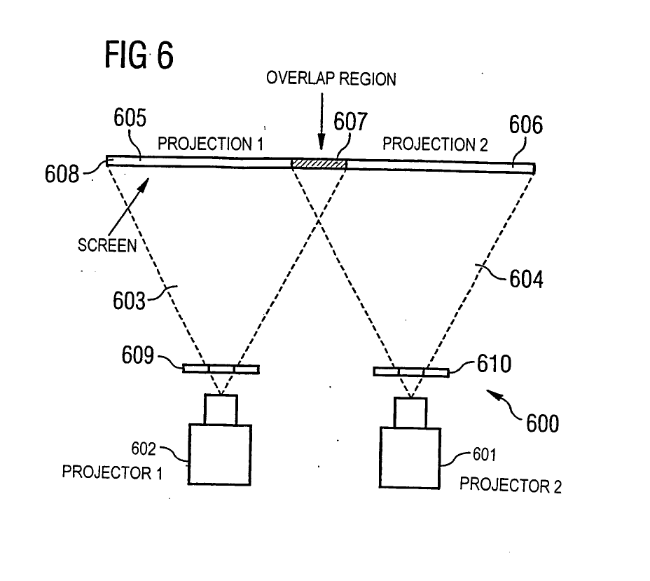

FIG. 6 shows the design 600 of a large-format projection system, in this case a two image projection system, a so-called hardware edge blending (large-format projection) system 601 (H-EBS).

The H-EBS 600 shown comprises a first H-EBS projector 601 and a second one 602, in this case LCD projectors, together with a large-format screen 608.

We note for clarification that any required projector, including for example a DLP projector, could be used for the H-EBS.

The first H-EBS projector 601 and the second one 602 each emits a projection beam in the form of an appropriate beam or projection cone, 603 and 604 respectively. Corresponding (individual) projections 605 and 606 respectively are rendered visible to a viewer by the incidence of the projection beam concerned, 603 and 604 respectively, on the large-format screen 608.

Into the projection cones or beam paths 603, 604 of the H-EBS projectors 601, 602 are inserted so-called H-EBS masking devices 609, 610 (FIG. 6).

The two H-EBS projectors 601 and 602 are oriented with respect to each other in such a way that the two projections 605 and 606 are visible beside each other on the large-format screen 608.

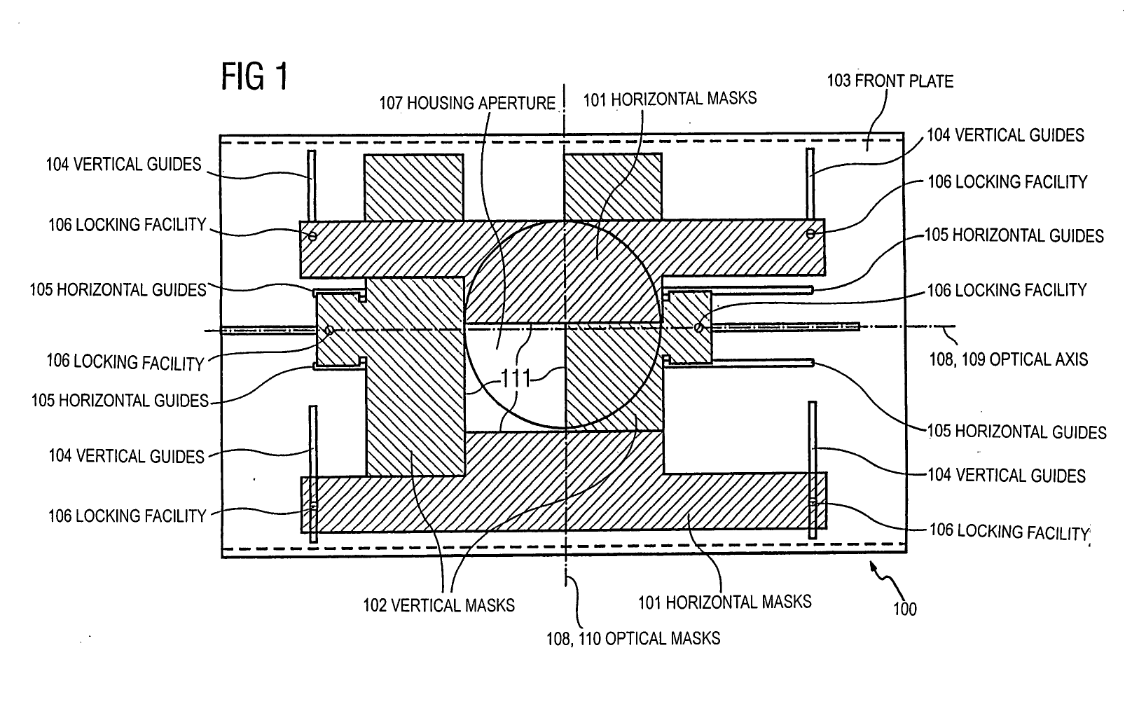

In an overlap region 607, which can be modified by the H-EBS masking devices 609, 610, i.e. enlarged or reduced in size (see also FIG. 1), the two projections 605 and 606 cover each other mutually (blend or blending region).

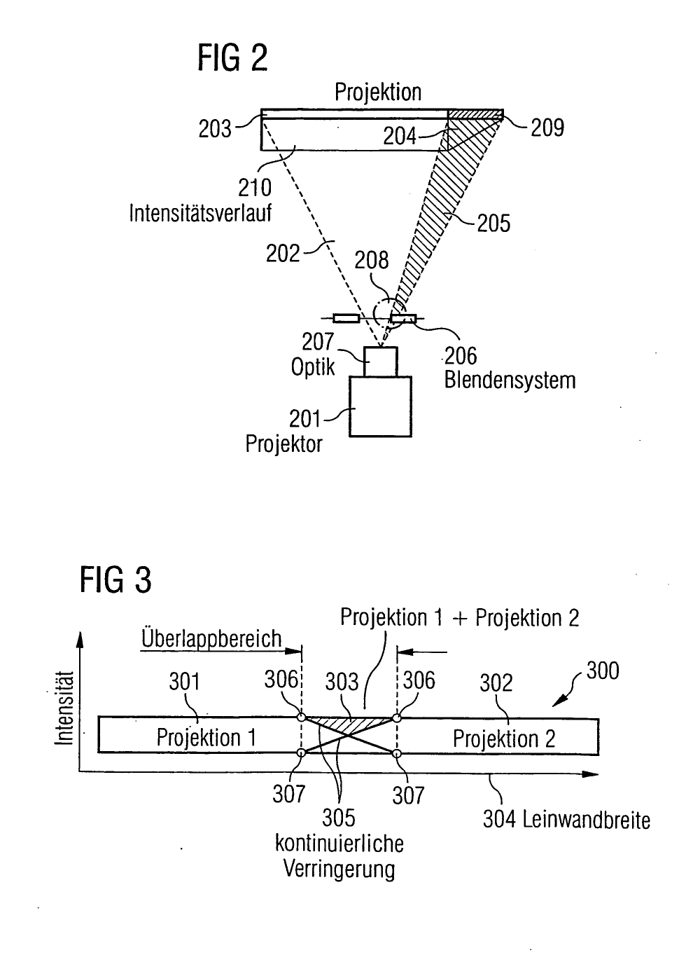

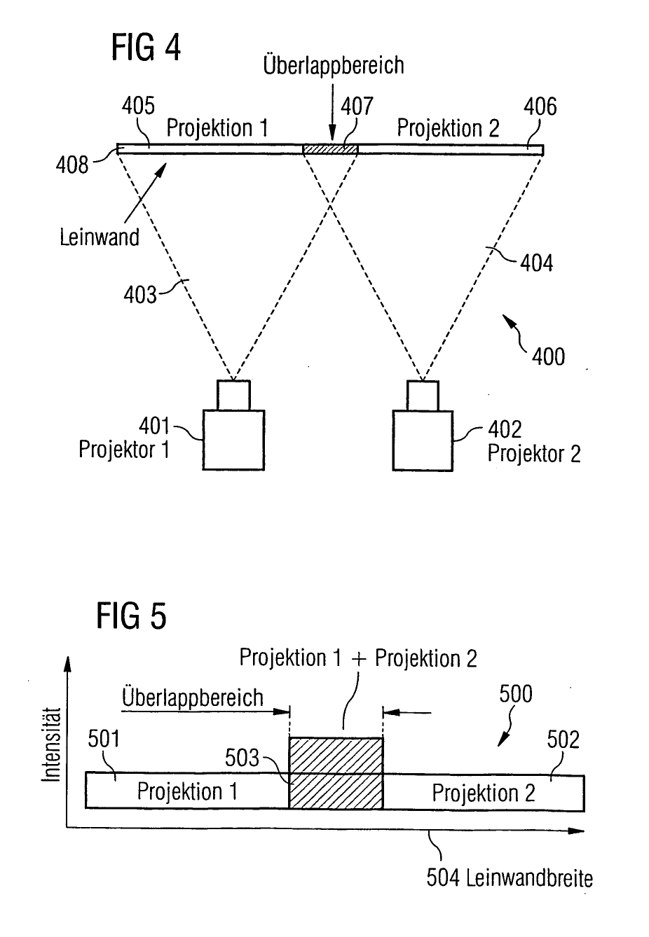

FIG. 2 shows the arrangement for an individual H-EBS projection 203, for one of the two H-EBS projectors 601 and 602, from porjector 201.

FIG. 2 shows in particular, 206, the H-EBS masking device 609 or 610 respectively which is inserted into the projection cone or beam path 202 of the H-EBS projector 201 (see also FIG. 1).

Here, when looking in the direction of the beam path 202 the H-EBS masking device 206 is located in front of the H-EBS projector 201 and after the projector optics 207.

The effect of a (beam) diffraction effect 205 at a mask edge 208 of the H-EBS masking device 206, which (beam) diffraction effect 205 is known from, is to achieve a virtually uniform masking out 204 of a projection 203, in this case a projected image 203, out toward an edge 209 of the image.

This has the effect that the intensity pattern 210 for an individual projection, in this case the projection 203, is reduced 204 as shown by the uniform (additive) intensity pattern 300 in FIG. 3 for the case of two projections 301 and 302 which are mutually overlapping over a section 303, and for which the intensities are reduced 306-307 out toward their edges 307.

In a mirror-image fashion, this reduction in the intensity is effected through a corresponding build-up for the second H-EBS projector 601 or 602, as applicable, so that the uniform (additive) intensity pattern 300 shown in FIG. 3 results over the blending region.

Thus the blending problem is solved with the H-EBS system described.

FIG. 1 shows the H-EBS masking device (which is inserted into the beam path 202 of the H-EBS projector 201), 609, 610, 206 and 100.

The H-EBS masking device 100 has a rectangular front plate 103, to which are attached vertical guides 104 and horizontal guides 105 for holding masks which can be moved respectively vertically 102 or horizontally 101.

Here, each of the masks 101,102 has a straight mask edge 111, with no curve in it.

Each of the masks 101, 102 can be displaced within its guides 104 or 105 respectively, and can be fixed in a desired position by locking facilities 106.

The front plate 103 is attached or aligned in front of the projector optics 207 of the H-EBS projector 201 in such a way that a horizontal axis of symmetry 109 and a vertical axis of symmetry 110 of the front plate 103 each corresponds with an optical axis 108 of the projected beam cone 202.

The horizontal and vertical arrangement of the masks 101, 102, and the free movement of the masks 101, 102, within their guides 104, 105, make it possible to set any desired apertures 107, in this case rectangular apertures, for letting through the projection beam.

A different shape for the masks 101, 102, or a different form for the mask edges 111, would also permit transmission apertures 107 with different shapes, for example curved transmission apertures 107.

This flexibility in the setting of the transmission aperture 107 permits all the edges of a projected image to be variably masked, and thereby the blending regions flexibly adapted (adjustment).

Important advantages of the H-EBS 600 which has been described are thus:

The adaptation of the blending region or the adjustment is flexible and simple.

By comparison with soft edge blending solutions, the cost outlay is critically reduced.

The occurrence of stray light is eliminated.

The H-EBS 600 is independent of the type of projector used and its input signal sources.

The invention has been described in detail with particular reference to preferred embodiments thereof and examples, but it will be understood that variations and modifications can be effected within the spirit and scope if the invention.

1-13. (canceled)

14. A projection system comprising:
a projection device equipped for the creation of a projection by emitting a projection beam that travels on a beam path; and
a masking device, which is inserted into the beam path of the projection beam in such a way that a section of the projection is masked out, and in such a way that across the section of the projection which is masked out there is a continuous reduction in the intensity of the projection beam.

15. The projection system in accordance with claim 14, wherein the section of the projection which is masked out is in a peripheral region of the projection.

16. The projection system in accordance with claim 14, wherein the intensity in the masked out section of the projection is reduced down to zero.

17. The projection system in accordance with claim 14, wherein the continuous reduction in the intensity is effected in accordance with a prescribed functional rule .

18. The projection system in accordance with claim 14, wherein the continuous reduction in the intensity is effected in accordance with a linear functional rule.

19. The projection system in accordance with claim 14, wherein the masking device is movable in the beam path, in such a way that the section which is masked out can be altered.

20. The projection system in accordance with claim 14, wherein the projection device is an LCD or a DLP projector.

21. The projection system in accordance with claim 14, wherein there are a plurality of masking devices, each of which masks out a section of the projection.

22. The projection system in accordance with claim 20, wherein a plurality of masking devices are inserted into the beam path in such a way to impart a predetermined shape to a section of the projection which is not masked out.

23. The projection system in accordance with claim 20, wherein a plurality of masking devices are inserted into the beam path in such a way to impart a cone shape to a section of the projection which is not masked out, the cone shape having a rectangular cross-section.

24. The projection system in accordance with claim 14, further comprising a projection screen for displaying the projection.

25. The projection system in accordance with claim 15, wherein the intensity in the masked out section of the projection is reduced down to zero.

26. The projection system in accordance with claim 25, wherein the continuous reduction in the intensity is effected in accordance with a linear functional rule.

27. The projection system in accordance with claim 26, wherein the masking device is movable in the beam path, in such a way that the section which is masked out can be altered.

28. The projection system in accordance with claim 27, wherein the projection device is an LCD or a DLP projector.

29. The projection system in accordance with claim 28, wherein there are a plurality of masking devices, each of which masks out a section of the projection.

30. The projection system in accordance with claim 29, wherein a plurality of masking devices are inserted into the beam path in such a way to impart a cone shape to a section of the projection which is not masked out, the cone shape having a rectangular cross-section.

31. The projection system in accordance with claim 30, further comprising a projection screen for displaying the projection.

32. A large-format projection unit comprising:
at least two projection systems, each equipped to create a projection by emitting a projection beam that travels on a beam path; and
at least two masking devices, each of which is located in a beam path of a projection beam emitted a corresponding projection device of the at least two projection devices, each masking device being located such that a section of the projection created by the corresponding projection device is masked out, and such that there is a continuous reduction in the intensity across the section of the projection which is masked out,
wherein the at least two projection systems are oriented with respect to each other in such a way that the masked out sections of the projections overlap at a mutually overlapping section.

33. The large-format projection unit in accordance claim 32, wherein the mutually overlapping section is formed in such a way that a combination of intensities of the at least two projection beams produces an intensity with a constant pattern in the mutually overlapping section.

34. The large-format projection unit in accordance with claim 33, wherein the projection systems are oriented in such a way with respect to each other that they produce a large-format projection with a prescribable shape.

35. The large-format projection unit in accordance with claim 33, wherein the projection systems are oriented in such a way with respect to each other that they produce a large format projection with a conical shape, the conical shape having a rectangular cross section.

36. The large-format projection unit in accordance with claim 32, further comprising a large-format projection screen for displaying the large-format projection.

37. The large-format projection unit in accordance with claim 35, further comprising a large-format projection screen for displaying the large-format projection.

38. The projection system in accordance with claim 14, wherein the masking device has an adjustable aperture which allows the projection beam to pass and has a surrounding area to block the projection beam.

39. The projection system in accordance with claim 38, wherein
the aperture has vertical masks and horizontal masks,
at least one of the vertical masks is movable toward and away from another of the vertical masks, and
at least one of the horizontal masks is movable toward and away from another of the horizontal masks.

40. The large-format projection unit in accordance with claim 32, wherein each masking device has an adjustable aperture which allows a projection beam to pass and has a surrounding area to block the projection beam.

41. The large-format projection unit in accordance with claim 40, wherein
the apertures each have vertical masks and horizontal masks,
for each masking device, at least one of the vertical masks is movable toward and away from another of the vertical masks, and
for each masking device, at least one of the horizontal masks is movable toward and away from another of the horizontal masks.
